(19) United States
(12) Patent Application Publication
(10) Pub. No.: US 2025/0089615 A1
(43) Pub. Date: Mar. 20, 2025

(54) SYSTEM AND METHOD FOR DETECTING DISEASES WITHIN HARVESTED MATERIALS DURING OPERATION OF AN AGRICULTURAL HARVESTER

(71) Applicants: CNH Industrial Brasil Ltda., Bairro Vale do Sereno (BR); CNH Industrial America LLC, New Holland, PA (US); CNH Industrial Belgium N.V., Zedelgem (BE)

(72) Inventors: João Augusto Marcolin Lucca, Piracicaba (BR); Daenio Cleodolphi, Piracicaba (BR); André Satoshi Seki, Sorocaba (BR); João Testa, Sorocaba (BR); Bart M.A. Missotten, Zedelgem (BE); Craig Jorgensen, Racine, WI (US)

(21) Appl. No.: 18/888,505

(22) Filed: Sep. 18, 2024

(30) Foreign Application Priority Data
Sep. 19, 2023 (BR) 10 2023 019018 9

(51) Int. Cl. A01D 43/08; A01D 45/10; G06T 7/00; G06T 7/70; G06V 20/10

(52) U.S. Cl. CPC A01D 43/085; G06T 7/0004; G06T 7/70; G06V 20/188; A01D 45/10; G06T 2207/10024; G06T 2207/30188

(57) ABSTRACT

In one aspect, a method for detecting diseases within harvested materials during operation of an agricultural harvester includes receiving, with a computing system, an image of billets created by a chopper assembly of the agricultural harvester; analyzing, with the computing system, the image to identify indications of disease in association with one or more of the billets contained within the image; and initiating, with the computing system, a control action in response to the identification of indications of disease in association with the one or more billets contained within the image.

### CROSS-REFERENCE TO RELATED APPLICATION

This application claims priority to Brazil Patent Application No. 10 2023 019018 9, filed Sep. 19, 2023, and entitled “SYSTEM AND METHOD FOR DETECTING DISEASES WITHIN HARVESTED MATERIALS DURING OPERATION OF AN AGRICULTURAL HARVESTER”, which is hereby expressly incorporated herein by reference in its entirety.

### FIELD OF THE INVENTION

The present disclosure relates generally to agricultural harvesters, such as sugarcane harvesters, and, more particularly, to systems and methods for detecting diseases within harvested materials during operation of an agricultural harvester.

### BACKGROUND OF THE INVENTION

Within the agricultural industry, diseased crops can present significant issues. In this regard, the fast and efficient detection of diseased crops is important to allow farmers to act quickly to mitigate losses and avoid spreading of the disease. For instance, in the sugarcane industry, certain fungal diseases, such as “red rot” disease, can often spread quickly across a field, which can lead to significant crop losses.

Currently, disease detection primarily relies upon the performance of a manual inspection within the field pre-harvesting or the performance of a manual inspection of the harvested materials post-harvesting once such materials are delivered to a centralized crop repository (e.g., an offsite crop processing center). As a result, pre-harvesting inspections are typically limited to a very small area of the field, which means that many diseased areas of the field can go undetected. Additionally, post-harvesting inspections at offsite locations can result in significant delay in the disease detection and also lacks the ability to identify the specific areas of the disease within the field

Accordingly, systems and methods for detecting diseases within harvested materials during operation of an agricultural harvester would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for detecting diseases within harvested materials during operation of an agricultural harvester. The method includes receiving, with a computing system, an image of billets created by a chopper assembly of the agricultural harvester; analyzing, with the computing system, the image to identify indications of disease in association with one or more of the billets contained within the image; and initiating, with the computing system, a control action in response to the identification of indications of disease in association with the one or more billets contained within the image.

In another aspect, the present subject matter is directed to a system for detecting disease within harvested materials during operation of an agricultural harvester. The system includes a chopper assembly configured to chop harvested materials into billets, and a vision-based sensor supported on or within the agricultural harvester. The vision-based sensor is configured to capture images of the billets created by the chopper assembly. Additionally, the system includes a computing system configured to: receive an image of billets captured by the vision-based sensor; analyze the image to identify indications of disease in association with one or more of the billets contained within the image; and initiate a control action in response to the identification of indications of disease in association with the one or more billets contained within the image.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of one embodiment of an agricultural harvester in accordance with aspects of the present subject matter;

FIG. 2 illustrates a perspective view of a rear portion of the agricultural harvester shown in FIG. 1 in accordance with aspects of the present subject matter, particularly illustrating a sensor assembly provided in operative association with an elevator assembly of the harvester to allow images of billets being transported within the elevator to be captured;

FIG. 3 illustrates an exemplary view of one embodiment of an image that can be captured using the sensor assembly shown in FIG. 2;

FIG. 4 illustrates a schematic view of one embodiment of a system for detecting diseases within harvester materials during operation of an agricultural harvester in accordance with aspects of the present subject matter; and

FIG. 5 illustrates a flow diagram of one embodiment of a method for detecting diseases within harvester materials during operation of an agricultural harvester in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part can be used with another embodiment to yield a still further embodiment. Thus, it is intended that the present invention covers such modifications and variations as come within the scope of the appended claims and their equivalents.

In general, the present subject matter is directed to systems and methods for detecting disease within harvested materials during operation of an agricultural harvester. Specifically, in several embodiments, a computing system of the disclosed system may be configured to receive images of billets being processed within the harvester and analyze such images to identify symptoms or indications of disease within the billets while the harvester is conducting a harvesting operation within the field. For instance, the computing system may be configured to analyze the images to identify discolorations, patterns, or other indicators of fungal diseases and other diseases as the billets are being processed within the harvester. As an example, the computing system may identify discolorations at the cut ends of the billets (e.g., red-colored regions or pockets at the cut ends) that are indicative of “red rot” disease. Upon detecting any indicators or symptoms of disease, the computing system may be configured to automatically initiate a control action, such as by generating an operator notification to alert the operator of the potential for diseased crops and/or by generating a field map that correlates to detected disease indicators/symptoms to specific locations within the field. Such control actions may allow an operator and/or a farm manager to react quickly and effectively to mitigate loses and prevent spreading of the disease.

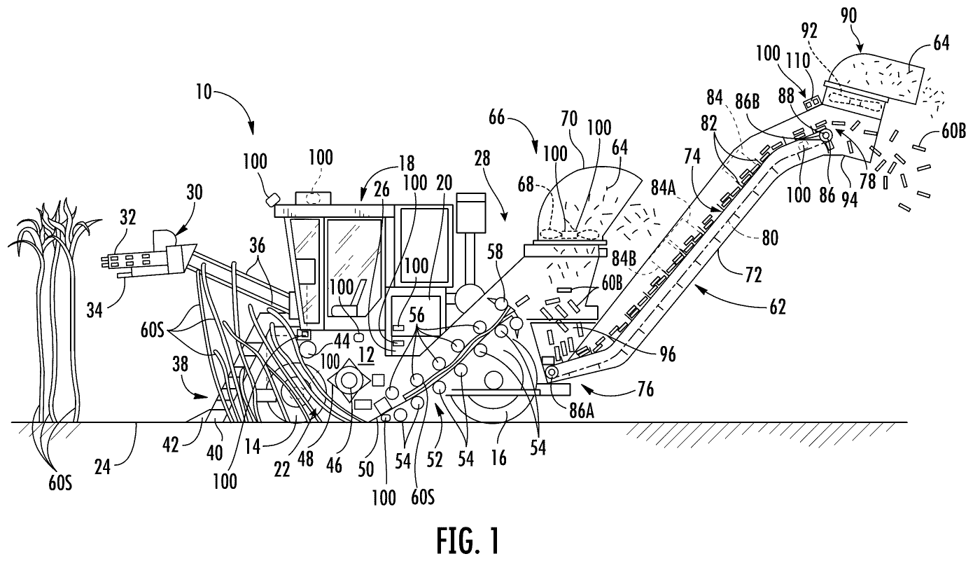

Referring now to the drawings, FIG. 1 illustrates a side view of an agricultural harvester 10 in accordance with aspects of the present subject matter. As shown, the harvester 10 is configured as a sugarcane harvester. However, in other embodiments, the harvester 10 may correspond to any other suitable agricultural harvester known in the art.

As shown in FIG. 1, the harvester 10 can include a frame 12, a pair of front wheels 14, a pair of rear wheels 16, and an operator's cab 18. The harvester 10 may also include a power source 20 (e.g., an engine mounted on the frame 12) that powers one or both pairs of the wheels 14, 16 via a driveline assembly 22 (e.g., a transmission) to traverse a field 24. Alternatively, the harvester 10 may be a track-driven harvester and, thus, may include tracks driven by the power source 20 as opposed to the illustrated wheels 14, 16. The power source 20 may also drive a hydraulic fluid pump 26 configured to generate pressurized hydraulic fluid for a hydraulic circuit, which may be configured to power various components of the harvester 10, including the driveline assembly 22.

The harvester 10 may also include a crop processing system 28 incorporating various components, assemblies, and/or sub-assemblies of the harvester 10 for cutting, processing, cleaning, and discharging sugarcane as the cane is harvested from an agricultural field 24. For instance, the crop processing system 28 may include a topper assembly 30 positioned at the front end portion of the harvester 10 to intercept sugarcane as the harvester 10 is moved in a forward direction. As shown, the topper assembly 30 may include both a gathering disk 32 and a cutting disk 34. The gathering disk 32 may be configured to gather the sugarcane stalks 60S so that the cutting disk 34 may be used to cut off the top of each stalk 60S. As is generally understood, the height of the topper assembly 30 may be adjustable via a pair of arms 36, which may be hydraulically raised and lowered.

The crop processing system 28 may further include a crop divider 38 that extends upwardly and rearwardly from the field 24. In general, the crop divider 38 may include two spiral feed rollers 40. Each feed roller 40 may include a ground shoe 42 at its lower end portion to assist the crop divider 38 in gathering the sugarcane stalks 60S for harvesting. Moreover, as shown in FIG. 1, the crop processing system 28 may include a knock-down roller 44 positioned near the front wheels 14 and a fin roller 46 positioned behind the knock-down roller 44. As the knock-down roller 44 is rotated, the sugarcane stalks 60S being harvested are knocked down while the crop divider 38 gathers the stalks 60S from agricultural field 24. Further, as shown in FIG. 1, the fin roller 46 may include a plurality of intermittently mounted fins 48 that assist in forcing the sugarcane stalks 60S downwardly. As the fin roller 46 is rotated during the harvest, the sugarcane stalks 60S that have been knocked down by the knock-down roller 44 are separated and further knocked down by the fin roller 46 as the harvester 10 continues to be moved in the forward direction relative to the field 24.

Referring still to FIG. 1, the crop processing system 28 of the harvester 10 may also include a base cutter assembly 50 positioned behind the fin roller 46. The base cutter assembly 50 may include blades for severing the sugarcane stalks 60S as the cane is being harvested. The blades, which may be located on a periphery section of the base cutter assembly 50, may be rotated by the hydraulic circuit. Additionally, in several embodiments, the blades may be angled downwardly to sever the base of the sugarcane as the cane is knocked down by the fin roller 46.

Moreover, the crop processing system 28 may include a feed roller assembly 52 located downstream of the base cutter assembly 50 for moving the severed stalks 60S of sugarcane from the base cutter assembly 50 along the processing path of the crop processing system 28. As shown in FIG. 1, the feed roller assembly 52 may include a plurality of bottom rollers 54 and a plurality of opposed, top rollers 56. The various bottom and top rollers 54, 56 may be used to pinch the harvested sugarcane during transport. As the sugarcane is transported through the feed roller assembly 52, debris (e.g., rocks, dirt, and/or the like) may be allowed to fall through bottom rollers 54 onto the field 24.

In addition, the crop processing system 28 may include a chopper assembly 58 located at the downstream end section of the feed roller assembly 52 (e.g., adjacent to the rearward-most bottom roller 54 and the rearward-most top roller 56). In general, the chopper assembly 58 may be used to cut or chop the severed sugarcane stalks 60S into pieces or “billets” 60B, which may be, for example, six (6) inches long. The billets 60B may then be propelled towards an elevator assembly 62 of the crop processing system 28 for delivery to an external receiver or storage device.

The pieces of debris 64 (e.g., dust, dirt, leaves, etc.) separated from the sugarcane billets 60B may be expelled from the harvester 10 through a primary extractor 66 of the crop processing system 28, which may be located downstream of the chopper assembly 58 and may be oriented to direct the debris 64 outwardly from the harvester 10. Additionally, an extractor fan 68 may be mounted within an extractor housing 70 of the primary extractor 66 for generating a suction force or vacuum sufficient to force the debris 64 through the primary extractor 66. The separated or cleaned billets 60B, which may be heavier than the debris 64 expelled through the extractor 66, may then fall downward to the elevator assembly 62.

As shown in FIG. 1, the elevator assembly 62 may include an elevator housing 72 and an elevator 74 extending within the elevator housing 72 between a lower, proximal end portion 76 and an upper, distal end portion 78. In some examples, the elevator 74 may include a looped chain 80 and a plurality of flights or paddles 82 attached to and spaced on the chain 80. The paddles 82 may be configured to hold the sugarcane billets 60B on the elevator 74 as the sugarcane billets 60B are elevated along a top span of the elevator 74 defined between its proximal and distal end portions 76, 78. A region 84 for retaining the harvested material may be defined between first and second paddles 82 operably coupled with the elevator 74. As such, a first region 84A may be defined between first and second paddles 82, a second region 84B may be defined between the second and a third paddle 82, and so on. Additionally, the elevator 74 may include lower and upper sprockets 86A, 86B positioned at its proximal and distal end portions 76, 78, respectively. As shown in FIG. 1, an elevator motor 88 may be coupled to one of the sprockets (e.g., the upper sprocket 86B) for driving the chain 80, thereby allowing the chain 80 and the paddles 82 to travel in a loop between the proximal and distal ends 76, 78 of the elevator 74.

Moreover, in some embodiments, pieces of debris 64 (e.g., dust, dirt, leaves, etc.) separated from the elevated sugarcane billets 60B may be expelled from the harvester 10 through a secondary extractor 90 of the crop processing system 28 coupled to the rear end portion of the elevator housing 72. For example, the debris 64 expelled by the secondary extractor 90 may be debris 64 remaining after the billets 60B are cleaned and debris 64 expelled by the primary extractor 66. As shown in FIG. 1, the secondary extractor 90 may be located adjacent to the distal end portion 78 of the elevator 74 and may be oriented to direct the debris 64 outwardly from the harvester 10. Additionally, an extractor fan 92 may be mounted at the base of the secondary extractor 90 for generating a suction force or vacuum sufficient to force the debris 64 through the secondary extractor 90. The separated, cleaned billets 60B, heavier than the debris 64 expelled through the primary extractor 66, may then fall from the distal end portion 78 of the elevator 74. In some instances, the billets 60B may fall through an elevator discharge opening 94 defined by the elevator assembly 62 into an external storage device, such as a sugarcane billet cart.

During operation, the harvester 10 traverses the agricultural field 24 for harvesting sugarcane. After the height of the topper assembly 30 is adjusted via the arms 36, the gathering disk 32 on the topper assembly 30 may function to gather the sugarcane stalks 60S as the harvester 10 proceeds across the field 24, while the cutting disk 34 severs the leafy tops of the sugarcane stalks 60S for disposal along either side of harvester 10. As the stalks 60S enter the crop divider 38, the ground shoes 42 may set the operating width to determine the quantity of sugarcane entering the throat of the harvester 10. The spiral feed rollers 40 then gather the stalks 60S into the throat to allow the knock-down roller 44 to bend the stalks 60S downwardly in conjunction with the action of the fin roller 46. Once the stalks 60S are angled downward as shown in FIG. 1, the base cutter assembly 50 may then sever the base of the stalks 60S from field 24. The severed stalks 60S are then, by the movement of the harvester 10, directed to the feed roller assembly 52.

The severed sugarcane stalks 60S are conveyed rearwardly by the bottom and top rollers 54, 56, which compresses the stalks 60S, makes them more uniform, and shakes loose debris 64 to pass through the bottom rollers 54 to the field 24. At the downstream end portion of the feed roller assembly 52, the chopper assembly 58 cuts or chops the compressed sugarcane stalks 60S into pieces or billets 60B (e.g., cane sections of a given billet length). The processed crop discharged from the chopper assembly 58 is then directed as a stream of billets 60B and debris 64 into the primary extractor 66. The airborne debris 64 (e.g., dust, dirt, leaves, etc.) separated from the billets 60B is then extracted through the primary extractor 66 using suction created by the extractor fan 68. The separated/cleaned billets 60B then be directed to an elevator hopper 96 into the elevator assembly 62 and travel upwardly via the elevator 74 from its proximal end portion 76 to its distal end portion 78. During normal operation, once the billets 60B reach the distal end portion 78 of the elevator 74, the billets 60B fall through the elevator discharge opening 94 to an external storage device. If provided, the secondary extractor 90 (with the aid of the extractor fan 92) blows out trash/debris 64 from the harvester 10, similar to the primary extractor 66.

In various examples, the harvester 10 may also include a sensor system including one or more sensor assemblies 100, with each sensor assembly 110 including one or more onboard sensor(s) for monitoring one or more operating parameters or conditions of the harvester 10. In some embodiments, one or more of the sensor assemblies 100 may include or incorporate one or more vision-based sensors 110 (e.g., one or more cameras and/or the like) used to capture sensor data indicative of one or more observable conditions or parameters associated with the harvester 10. For instance, as shown in FIG. 1, a sensor assembly 100 including one or more vision-based sensors 110 is installed proximate to the elevator housing 72. As will be described below, the vision-based sensor(s) 110 may have a field of view directed towards the elevator 74 to allow images or other vision-based data to be captured in relation to the billets 60B being transported by the elevator 74 downstream of the chopper assembly 58.

The various sensor assemblies 100 may also include or be associated with various different speed sensors for monitoring the speed of the harvester 10, and/or the operating speed of one or more components of the harvester 10. In several embodiments, the speed sensors may be used to detect or monitor various different speed-related parameters associated with the harvester 10, including, but not limited to, the ground speed of the harvester 10, the engine speed of the harvester's engine (e.g., engine RPM), the elevator speed of the elevator assembly 62, the rotational speed of the blades of the base cutter assembly 50, the rotational speed of the chopper assembly 58 (hereinafter referred to as the “chopper speed”), the rotational speed of the rollers 54, 56 of the feed roller assembly 52 (hereinafter referred to as the “feed roller speed”), the fan speed associated with the primary extractor 66 and/or the secondary extractor 90, and/or any other suitable operating speeds associated with the harvester 10.

Additionally, in several embodiments, the sensor assemblies 100 may include or incorporate one or more position sensors used to monitor one or more corresponding position-related parameters associated with the harvester 10. Position-related parameters that may be monitored via the position sensor(s) include, but are not limited to, the cutting height of the base cutter assembly 50, the relative positioning of the bottom and top rollers 54, 56 of the feed roller assembly 52, the vertical travel or position of the chassis or frame 12 of the harvester 10, and/or any other suitable position-related parameters associated with the harvester 10.

Moreover, in several embodiments, the sensor assemblies 100 may include or incorporate one or more pressure sensors used to monitor one or more corresponding pressure-related conditions or parameters associated with the harvester 10. For instance, pressure-related conditions or parameters that may be monitored via the pressure sensor(s) include, but are not limited to, the fluid pressures associated with the hydraulic fluid supplied to one or more hydraulic components of the harvester 10, such as hydraulic motor(s) rotationally driving the base cutter assembly 50 (e.g., the base cutter pressure), hydraulic motor(s) rotationally driving the feed roller assembly 52, hydraulic motor(s) rotationally driving the chopper assembly 58, hydraulic motor(s) rotationally driving the fan 68 of the primary extractor 66, hydraulic motor(s) rotationally driving the elevator assembly 62, hydraulic motor(s) rotationally driving the secondary extractor 90, and/or any other suitable pressure-related conditions or parameters associated with the harvester 10.

It will be appreciated that the sensor assemblies 100 may also include various other sensors or sensing devices. In some embodiments, the harvester 10 may include or incorporate one or more load sensors (e.g., one or more load cells or sensorized load plates) used to monitor one or more corresponding load-related conditions or parameters associated with the harvester 10.

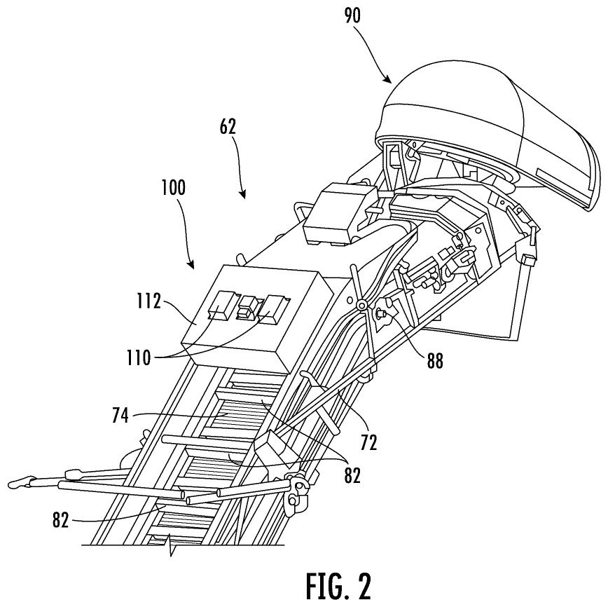

Referring now to FIG. 2, a perspective view of a rear portion of the agricultural harvester 10 shown in FIG. 1 is illustrated in accordance with aspects of the present subject, particularly illustrating the vision-based sensor assembly 100 described above. As shown, the sensor assembly 100 is operably coupled with the elevator housing 72 and includes one or more vision-based sensors 110 supported within a sensor housing 112. In one embodiment, the vision-based sensor(s) 110 may have a lens or any other suitable optical element(s) producing a field of view directed towards the elevator 74 to allow images or other vision-based data to be captured. In various examples, each vision-based sensor(s) 110 may be configured as an area-type image sensor, such as a CCD or a CMOS image sensor, and, thus, may include image-capturing optics that capture an image of an imaging field. In one embodiment, the image sensor may correspond to a monolithic or non-stereo sensor configured to capture two-dimensional images. In another embodiment, the image sensor may correspond to a stereographic camera having two or more lenses with a separate image sensor for each lens to allow the camera to capture stereographic or three-dimensional images.

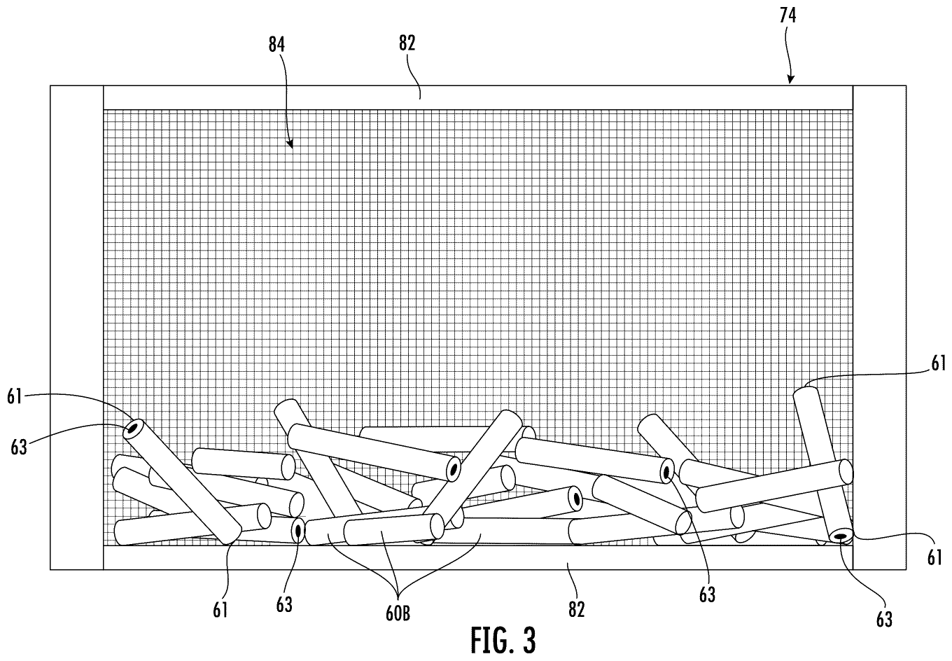

In accordance with aspects of the present subject matter, the images or other data captured by the vision-based sensor(s) 110 may be used for determining data associated with the billets 60B being transported through the elevator assembly 62. For instance, FIG. 3 illustrates an example view of an image captured by the vision-based sensor(s) 110 associated with the elevator 74, particularly illustrating billets 60B captured within one of the areas 84 defined between adjacent paddles 82 of the elevator 74. As will be described below, the images captured by the vision-based sensor(s) 110 may be analyzed to detect an indication or symptom of a disease within the billets 60B. For example, in several embodiments, the images captured by the vision-based sensor(s) 110 can be analyzed using suitable computer vision techniques to identify variations in the color of the billets 60B that may be indicative of disease (e.g., discolored areas that differ from the normal or expected color of the billets 60b). Specifically, in one embodiment, the images may be analyzed to identify one or more cut ends 61 of the various individual billets 60B contained within each image (e.g., by detecting the edges of each billet 60B and then identifying the cut ends 61), which may then allow the color of the cut ends 61 to be assessed to identify symptoms of disease. For instance, as shown in FIG. 3, symptoms or indications of red rot disease may include billets with a red-colored interior, which can be detected within the images at the cut ends 61 as reddish or discolored regions (indicated by solid areas 63 in FIG. 3). Other diseases may be characterized by other visually-recognizable symptoms or indications, such different types of discolorations, patterns, deformities, and/or the like. Thus, depending on the type of disease(s) being assessed or monitored, the specific characteristic or indications being identified within the images may vary.

It should be appreciated that, as an alternative to being provided in operative association with the elevator assembly 62, the vision-based sensor(s) 110 may be disposed at any other suitable location on or within the harvester 10 that allows images of billets 60B to be captured. For instance, in general, the vision-based sensor(s) 100 may be placed at any suitable location at or downstream of the chopper assembly 58 that enables the billets 60B created by the chopper assembly 58 to be imaged.

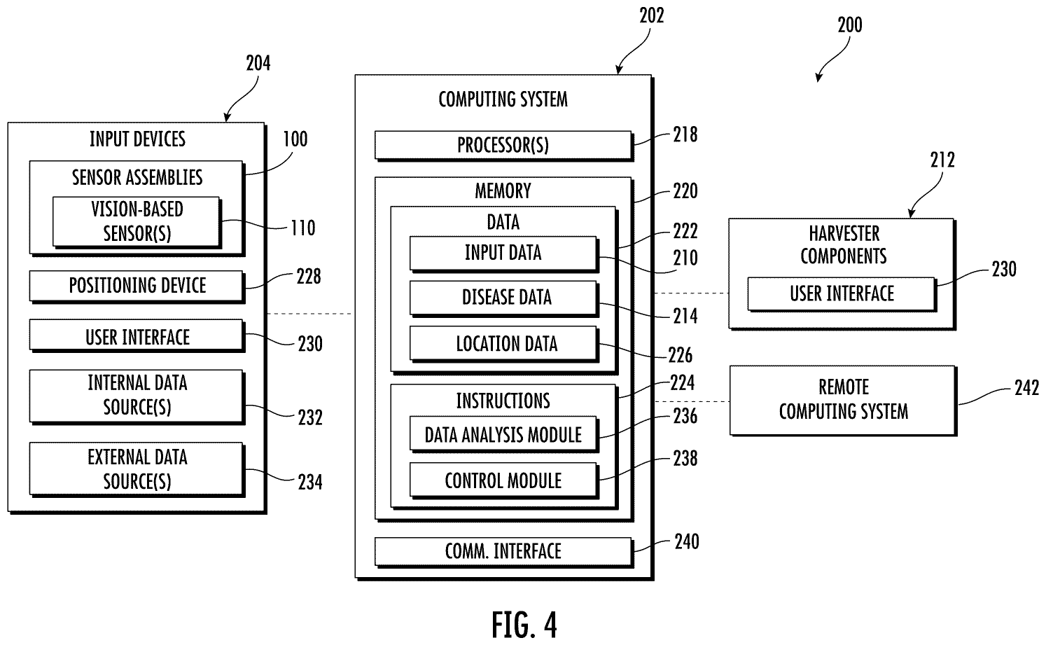

Referring now to FIG. 4, a schematic view of one embodiment of a system 200 for detecting disease in harvested materials during operation of an agricultural harvester is illustrated in accordance with aspects of the present subject matter. In general, the system 200 will be described herein with reference to the harvester 10 described above with reference to FIGS. 1 and 2. However, it will be appreciated that the disclosed system 200 may generally be utilized with harvesters having any suitable harvester configuration.

In several embodiments, the system 200 may include a computing system 202 and various other components configured to be communicatively coupled to and/or controlled by the computing system 202, such as various input devices 204 and/or various components 212 of the harvester 10. In some embodiments, the computing system 202 is physically coupled to the harvester 10. In other embodiments, the computing system 202 is not physically coupled to the harvester 10 and instead may communicate with the harvester 10 over a network.

As will be described in greater detail below, the computing system 202 may be configured to utilize a data analysis module 236 to detect symptoms or indications of disease within harvested materials (e.g., the billets 60B being processed by an agricultural harvester 10). In particular, FIG. 4 illustrates a computing environment in which the computing system 202 can operate to detect symptoms or indications of disease in billets 60B based on image data received, for example, from one or more vision-based sensors 110 and, further, to initiate one or more control actions based on the detection of such disease, such as by controlling a user interface 230 to display information to an operator associated with the detection of disease within the harvested materials. Thus, FIG. 4 illustrates a computing environment in which the computing system 202 is actively used in conjunction with a harvester 10 (e.g., during the operation of the harvester 10 within a field 24 (FIG. 1)).

In general, the computing system 202 may correspond to any suitable processor-based device(s), such as a computing device or any combination of computing devices. Thus, as shown in FIG. 4, the computing system 202 may generally include one or more processor(s) 218 and associated memory devices 220 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 220 may generally comprise memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 220 may generally be configured to store information accessible to the processor(s) 218, including data 222 that can be retrieved, manipulated, created, and/or stored by the processor(s) 218 and instructions 224 that can be executed by the processor(s) 218.

In several embodiments, the data 222 may be stored in one or more databases. For example, the memory 220 may include an input database 210 for storing input data received from the input device(s) 204. For example, the input device(s) 204 may include one or more of the sensor assemblies 100 described above that are configured to monitor one or more parameters and/or conditions associated with the harvester 10 and/or the operation being performed therewith. For instance, the input device(s) 204 may include the vision-based sensor(s) 110 described above. Additionally, the input device(s) 204 may further include one or more positioning device(s) 228 for generating position data associated with the location of the harvester 10, one or more user interfaces 230 for allowing operator inputs to be provided to the computing system 202 (e.g., buttons, knobs, dials, levers, joysticks, touch screens, and/or the like), one or more other internal data sources 232 associated with the harvester 10 (e.g., other devices, databases, etc.), one or more external data sources 234 (e.g., a remote computing device or sever, and/or any other suitable input device(s) 204. The data received from the input device(s) 204 may, for example, be stored within the input database 210 for subsequent processing and/or analysis. For instance, as will be described below, images or other data received from the vision-based sensors 110 may be temporarily or permanently stored within the database 210 to allow the computing system 202 to perform suitable image processing techniques for identifying one or more symptoms or indications of disease in association with the billets 60B contained within the images captured by the vision-based sensor(s) 110.

It will be appreciated that, in addition to being considered an input device(s) 204 that allows an operator to provide inputs to the computing system 202, the user interface 230 may also function as an output device. For instance, the user interface 230 may be configured to allow the computing system 202 to provide feedback or notifications to the operator (e.g., visual feedback via a display or other presentation device, audio feedback via a speaker or other audio output device, and/or the like). In this regard, as shown in FIG. 4, the user interface 230 is illustrated an example of a suitable harvester component 212 that can be electronically controlled by the computing system 202.

Additionally, as shown in FIG. 4, the memory 220 may include a disease database 214 for storing information associated with any disease-related data for the billets 60B being processed by harvester 10. For example, as indicated above, based on the image data received from the vision-based sensor(s) 110, the computing system 202 may be configured to identify one or more indications or symptoms of a disease(s) within the imaged billets 60B, such as by identifying discolorations (e.g., red-colored regions at the cut ends of the billets 60B) or any other disease symptoms associated with the billets. Any data associated with such detected disease symptoms or indications may then be stored within the disease database 214 for subsequent processing and/or analysis.

Moreover, in several embodiments, the memory 220 may also include a location database 226 storing location information about the harvester 10 and/or information about the field 24 (FIG. 1) being processed (e.g., a field map). Such location database 226 may, for example, correspond to a separate database or may form part of the input database 210. As shown in FIG. 4, the computing system 202 may be communicatively coupled to the positioning device(s) 228 installed on or within the harvester 10. For example, the positioning device(s) 228 may be configured to determine the exact location of the harvester 10 using a satellite navigation position system (e.g., a GPS, a Galileo positioning system, the Global Navigation satellite system (GLONASS), the BeiDou Satellite Navigation and Positioning system, and/or the like). In such an embodiment, the location determined by the positioning device(s) 228 may be transmitted to the computing system 202 (e.g., in the form of coordinates) and subsequently stored within the location database 226 for subsequent processing and/or analysis.

Additionally, in several embodiments, the location data stored within the location database 226 may also be correlated to all or a portion of the input data stored within the input database 210. For instance, the location coordinates derived from the positioning device(s) 228 and the data received from the input device(s) 204 may both be time-stamped. In such an embodiment, the time-stamped data may allow the data received from the input device(s) 204 to be matched or correlated to a corresponding set of location coordinates received from the positioning device(s) 228, thereby allowing the precise location of the portion of the field 24 (FIG. 1) associated with the input data to be known (or at least capable of calculation) by the computing system 202.

Moreover, by matching the input data to a corresponding set of location coordinates, the computing system 202 may also be configured to generate or update a corresponding field map associated with the field 24 (FIG. 1) being processed. For example, in instances in which the computing system 202 already includes a field map stored within its memory 220 that includes location coordinates associated with various points across the field 24 (FIG. 1), the input data received from the input device(s) 204 may be mapped or correlated to a given location within the field map. Alternatively, based on the location data and the associated image, the computing system 202 may be configured to generate a field map for the field 24 (FIG. 1) that includes the geo-located input data associated therewith.

As an example, any disease-related data derived from the images captured by the vision-based sensor(s) 110 can be matched to a corresponding set of location coordinates. For example, the particular location data associated with a particular image or set of images can simply be inherited by any disease-related data produced on the basis of or otherwise derived from such image(s). Thus, based on the location data and the associated disease-related data, the computing system 202 may be configured to generate a field map for the field 24 (FIG. 1) that describes or correlates, for each analyzed portion of the field 24 (FIG. 1), an indication of whether symptoms of disease were detected within the harvested materials deriving from such portion of the field. Such a map can be consulted to identify diseased portions within the field 24 (FIG. 1) or to allow an operator to subsequently check or assess such portions of the field 24 for additional evidence of disease (including to confirm the determination made by the computing system 202 that disease is present).

Referring still to FIG. 4, in several embodiments, the instructions 224 stored within the memory 220 of the computing system 202 may be executed by the processor(s) 218 to implement a data analysis module 236. In general, the data analysis module 236 may be configured to analyze the input data (e.g., a set of input data received at a given time or within a given time period or a subset of the data, which may be determined through a pre-processing method) received from one or more of the various input devices 204. Specifically, in one embodiment, the data analysis module 236 may be configured to analyze the image data received from the vision-based sensor(s) 110 to identify or detect symptoms or indications of disease within the billets 60B being processed by the harvester 10. For example, as indicated above, the data analysis module 236 may be configured to implement suitable computer-vision techniques that allow the computing system 202 to identify individual billets 60B within each captured image (e.g., edge-detection techniques or any other suitable computer-vision techniques), including the detection of ends or “cut ends” 61 of the billets 60B. In addition, in one embodiment, the data analysis module 236 may be configured to implement suitable computer-vision techniques that allow the computing system 202 to perform a color analysis of the imaged billets 60B. For instance, as indicated above, certain diseases may be characterized by discolorations on or within the billets 60B, such as discolored spots or regions 63 at the cut ends 61 of the billets 60B.

In various examples, the data analysis module 236 may be configured to leverage a machine-learned model for identifying disease symptoms or indications within the billets 60B. In such instances, the machine-learned model may be a machine-learned disease identification model, a machine-learned image processing model, and/or any other suitable machine-learned model. In one embodiment, the machine-learned model can be configured to receive the image data derived from the vision-based sensor(s) 110 and process the data to identify disease symptoms or indications in association with the billets being processed by the harvester 10. For example, in various instances, the instructions 224, when executed by the one or more processors, can configure the computing system to perform various operations including obtaining image data associated with billets being processed by the harvester 10, inputting the data into a machine-learned disease identification model, and receiving a probability of the presence of disease in association with the imaged billets 60B as the output of the machine-learned model.

It should be appreciated that, in several embodiments, the data analysis module 236 may be configured to analyze the images received from the vision-based sensor(s) 110 at a given frequency. For instance, in one embodiment, the data analysis module 236 may be configured to grab an image from the vision-based sensor(s) 110 at a certain time interval (e.g., every 30 seconds) or at a certain elevator interval (e.g., every 1-4 loops of the elevator 74). The image may then be analyzed to detect any indications of disease. Thereafter, following the next interval, the data analysis module 236 may, again, grab an image from the vision-based sensor(s) 110 and analyze the image for any indications of disease.

Referring still to FIG. 4, the instructions 224 stored within the memory 220 of the computing system 202 may also be executed by the processor(s) 218 to implement a control module 238. In various examples, the control module 238 may be configured to automatically control the operation of one or more harvester components 212. Specifically, in several embodiments, the control module 238 may be configured to initiate one or more control actions in response to the detection of disease symptoms or indications associated with the imaged billets 60B. For instance, a suitable control action may include the generation of an operator notification that can be displayed or presented to an operator via the user interface 230. As an example, the computing system 202 may control the operation of the user interface 230 in a manner that causes data associated with the detected diseased symptoms or indications to be presented to the operator of the harvester 10, such as by presenting images, numerical values, graphs, maps, and/or any other suitable visual indicators. In addition to generating an operator notification, the control module 238 may also be configured to communicate or transmit a suitable notification to a remote computing system 242 (e.g., a remote control center for the harvesting operations or a remote server). For example, data associated with the detection of disease symptoms or indications within the billets 60B (e.g., images, numerical values, graphs, maps, and/or any other suitable visual indicators) may be communicated to the remote computing system 242 via a suitable network (e.g., a wireless network).

Additionally, in some embodiments, the control action initiated by the computing system 202 may be associated with the generation of a map based at least in part on the detected disease symptoms or indications. For instance, as indicated above, the location coordinates derived from the positioning device(s) 228 and the image data (and associated disease-related data) may both be time-stamped. In such an embodiment, the time-stamped data may allow each image (and any associated disease-related data) to be matched or correlated to a corresponding set of location coordinates received from the positioning device(s) 228, thereby allowing the precise location of the portion of the field 24 (FIG. 1) associated with the value/datapoint to be determined by the computing system 202. The resulting “disease” map may, for example, simply correspond to a data table that maps or correlates detected disease symptoms or indications to an associated field location. Alternatively, the “disease” map may be presented as a geo-spatial mapping of the disease-related data, such as a heat map that indicates the presence of potential diseased crops across the field 24 (FIG. 1). Regardless, the generated map may be displayed to the operator (e.g., via the user interface 230) or may be transmitted to the remote computing system 242.

Moreover, as shown in FIG. 4, the computing system 202 may also include a communications interface 240 to communicate with any of the various other system components described herein. For instance, one or more communicative links or interfaces (e.g., one or more data buses and/or wireless connections) may be provided between the communications interface 240 and the input device(s) 204 to allow data transmitted from the input device(s) 204 to be received by the computing system 202. Additionally, as shown in FIG. 4, one or more communicative links or interfaces (e.g., one or more data buses and/or wireless connections) may be provided between the communications interface 240 and one or more electronically controlled harvester components 212 (e.g., the user interface 230) to allow the computing system 202 to control the operation of such system components. Similarly, as shown in FIG. 4, one or more communicative links or interfaces (e.g., a wireless connection) may be provided between the communications interface 240 and the remote computing system 242 to allow the computing system 202 to communicate with such other system 242.

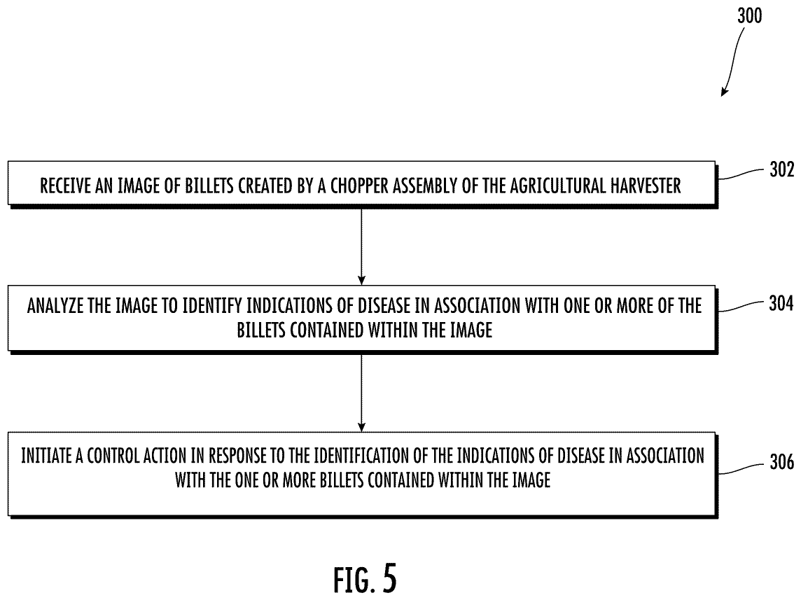

Referring now to FIG. 5, a flow diagram of one embodiment of a method 300 for detecting disease within harvester materials during operation of an agricultural harvester is illustrated in accordance with aspects of the present subject matter. In general, the method 300 will be described herein with reference to the agricultural harvester 10 and related components described with reference to FIGS. 1-2, and the various components of the system 200 described with reference to FIG. 4. It will be appreciated, however, that the disclosed method 300 may be implemented with harvesters having any other suitable configurations and/or within systems having any other suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 5, at (302), the method 300 may include receiving an image of billets created by a chopper assembly of the agricultural harvester. For instance, as indicated above, the computing system 202 may be communicatively coupled to a vision-based sensor(s) configured to capture images of the billets 60B being processed by the harvester 10, thereby allowing the images to be transmitted to and received by the computing system 202.

Additionally, at (304), the method 300 may include analyzing the image to identify indications of disease in association with one or more of the billets contained within the image. For instance, as indicated above, the computing system 202 may be configured to execute suitable computer-vision techniques to analyze the images captured by the vision-based sensor(s) 110 and determine whether any symptoms or indications of disease are present in association with the imaged billets 60B. For instance, the computing system 202 may be configured to identify discolored regions of area of the billets 60B (e.g., at the cut ends) that are indicative of disease (e.g., “red rot” disease).

Moreover, at (306), the method 300 may include initiating a control action in response to the identification of indications of disease in association with the one or more billets contained within the image. Specifically, as indicated above, the computing system may, for example, be configured to generate a notification (e.g., an operator notification or notification to be sent to a remote command center) upon the detection of disease symptoms. In addition, the computing system 202 may be configured to generate a field map that correlates the detected disease symptoms to the specific locations within the field at which such symptoms were detected.

It is to be understood that the steps of any method disclosed herein may be performed by a computing system upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions which are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method for detecting diseases within harvested materials during operation of an agricultural harvester, the method comprising:
receiving, with a computing system, an image of billets created by a chopper assembly of the agricultural harvester;
analyzing, with the computing system, the image to identify indications of disease in association with one or more of the billets contained within the image; and
initiating, with the computing system, a control action in response to the identification of indications of disease in association with the one or more billets contained within the image.

2. The method of claim 1, wherein receiving the image of billets comprises receiving the image from a vision-based sensor located on or within the agricultural harvester at a location downstream of the chopper assembly.

3. The method of claim 2, wherein the vision-based sensor comprises at least one camera.

4. The method of claim 2, wherein the vision-based sensor is provided in operative association with an elevator assembly of the agricultural harvester.

5. The method of claim 1, wherein analyzing the image to identify indications of disease comprises analyzing the image to identify a discoloration in association with the one or more billets that is indicative of a disease.

6. The method of claim 5, wherein analyzing the image to identify the discoloration comprises analyzing the image to identify a discolored region at a cut end of the one or more billets.

7. The method of claim 6, wherein the discolored region is a red-colored region indicative of red rot disease.

8. The method of claim 1, wherein initiating the control action comprises generating a notification in response to the identification of indications of disease.

9. The method of claim 8, further comprising presenting the notification to an operator via a user interface of the agricultural harvester or transmitting the notification to a remote computing system.

10. The method of claim 1, wherein initiating the control action comprises generating a map that correlates the identified indications of disease to locations within a field.

11. A system for detecting disease within harvested materials during operation of an agricultural harvester, the system comprising:
a chopper assembly configured to chop harvested materials into billets;
a vision-based sensor supported on or within the agricultural harvester, the vision-based sensor being configured to capture images of the billets created by the chopper assembly; and
a computing system configured to:
receive an image of billets captured by the vision-based sensor;
analyze the image to identify indications of disease in association with one or more of the billets contained within the image; and
initiate a control action in response to the identification of indications of disease in association with the one or more billets contained within the image.

12. The system of claim 11, wherein the vision-based sensor is located on or within the agricultural harvester at a location downstream of the chopper assembly.

13. The system of claim 11, wherein the vision-based sensor is provided in operative association with an elevator assembly of the agricultural harvester.

14. The system of claim 11, wherein the vision-based sensor comprises at least one camera.

15. The system of claim 11, wherein the computing system is configured to analyze the image to identify a discoloration in association with the one or more billets that is indicative of a disease.

16. The system of claim 15, wherein the computing system is configured to analyze the image to identify a discolored region at a cut end of the one or more billets.

17. The system of claim 16, wherein the discolored region is a red-colored region indicative of red rot disease.

18. The system of claim 11, wherein the control action comprises the generation of a notification in response to the identification of indications of disease.

19. The system of claim 18, wherein the computing system is further configured to present the notification to an operator via a user interface of the agricultural harvester or transmit the notification to a remote computing system.

20. The system of claim 11, wherein the control action comprises the generation of a map that correlates the identified indications of disease to locations within a field along which the agricultural harvester is operating.
